(19) United States
(12) Patent Application Publication
(10) Pub. No.: US 2008/0006756 A1
(43) Pub. Date: Jan. 10, 2008

(54) Earth Anchor

(76) Inventors: Donald Eugene Mitchell, Stillwater, OK (US); Judith F. Mitchell, Stillwater, OK (US); Taylor Mitchell, Stillwater, OK (US); Austin McClain Mitchell, Stillwater, OK (US)

Correspondence Address: MARTIN S. HIGH, P.O. BOX 217, STILLWATER, OK, 74076, US

(21) Appl. No.: 11/766,141

(22) Filed: Jun. 21, 2007

Related U.S. Application Data
(60) Provisional application No. 60/805,867, filed on Jun. 26, 2006.

(51) Int. Cl. F16M 11/04

(52) U.S. Cl. 248/545

(57) ABSTRACT

The instant invention, the earth anchor, is comprised of a foundation plate, a connecting column, a strap anchor guide, a strap anchor bolt (pin) and a strap anchor. The foundation plate is an essentially flat metal plate that is permanently affixed to the bottom of the connecting column. The connecting column is a hollow cylinder that extends the length of the excavated opening. The strap anchor bolt is secured through the connecting column by an opening formed in the connecting column near the top of the connecting column. The foundation plate, the connecting column, the strap guide anchor and the strap anchor bolt (pin) are manufactured from a metallic or rigid polymeric material. The strap anchor is a flexible material that extends around the strap anchor bolt (pin) and around the back or side ground shoe (bar) when used in an application involving the securing of a sports goal.

### CROSS-REFERENCE TO RELATED APPLICATIONS

This application claims the benefit of U.S. Provisional Application No. 60/805,867 filed on Jun. 26, 2006 titled “Earth Anchor,” which is incorporated herein by reference.

### STATEMENT REGARDING FEDERALLY SPONSORED RESEARCH OR DEVELOPMENT

Not applicable.

### REFERENCE TO A “SEQUENCE LISTING,” A TABLE, OR A COMPUTER PROGRAM LISTING

Not applicable.

### BACKGROUND OF THE INVENTION

1. Field of Invention

The field of the instant invention (the “Earth Anchor”), is generally in the area of portable, secure support or anchors to secure objects outdoors to the earth. More specifically, one of the fields of the Earth Anchor involves restraint of sports goals including the support and restraint of soccer goals. The U.S. Consumer Product Safety Commission estimates that there are 225,000 to 500,000 soccer goals in the country. See Consumer Product Safety Commission, Guidelines for Movable Soccer Goal Safety, CPSC Document #326, available at http://www.cpsc.gov/cpscpub/pubs/326.html (visited Jun. 1, 2006) (hereinafter “Guidelines”). The Guidelines also state that tip-over of soccer goals resulted in four deaths in 1990 and at least 21 deaths from 1979 to 1994. The Guidelines state that
[t]he majority of movable soccer goals are constructed of metal, typically weighing 150-500 pounds. The serious injuries and deaths are a result of blunt force trauma to the head, neck, chest, and limbs of the victims. In most cases this occurred when the goal tipped or was accidentally [sic] tipped onto the victim. In one case an 8-year-old child was fatally injured when the movable soccer goal he was climbing tipped over and struck him on the head. In another case, a 20-year-old male died from a massive head trauma when he pulled a goal down on himself while attempting to do chin-ups. In a third case, while attempting to tighten a net to its goal post, the victim's father lifted the back base of the goal causing it to tip over striking his 3-year-old child on the head, causing a fatal injury.”

### Id.at § 2. One purpose of the Earth Anchor is to provide a means to secure sports goals, including soccer goals, so that these tip over injuries and deaths are prevented.

The Earth Anchor can also serve as a landscape anchor for trees, and shrubs. The instant invention, the Earth Anchor, can serve as tent anchors for larger tents over longer durations such as in outdoor venues such as farmer's markets, outdoor arts and crafts fairs, where temporary shade tents are in need of anchors. Earth Anchors can be permanently installed in display areas to secure positive anchoring points for these structures. The Earth Anchor can be used to secure playground equipment including swings, wooden recreation sets in home, school and commercial use. The Earth Anchor can also be used as an anchor for dog tethers or leashes.

In other applications, the Earth Anchor can be used to anchor porous screens or coverings that are commonly used to serve as wind or sight blocks on chain link fences. These porous screens continually pull loose from the fence under high wind conditions, and the Earth Anchor can be used to anchor the screens to the ground instead of the fence itself with much better results. Additional applications include security anchoring of outdoor vending machines, merchandise displays and support for cables such as guideline or guy line wires.

In general, the Earth Anchor can be used in any application where an object needs to be secured to the earth.

2. Description of Prior Art

The prior art pertinent to the field of the instant invention can generally be described as “ad hoc” solutions to the long standing problem of securely and safely maintaining the position of sports goals. The prior art is as simplistic as placing a weight on one of the side or rear ground bars (commonly called shoes) of the sports goal to prevent the rear ground bar (shoe) from lifting off the ground. This weight is likely any object at hand such as a bucket filled with gravel, water or sand. The weight may also be a bag of sand, concrete or gravel. In any case, the solution to prevent the rear ground bar (shoe) from lifting off the ground can be a hazard to the participants in the sport using the goal. The participants may trip over the weight or fall into the weighted object thereby harming themselves. In addition, using this method in and of itself presents a physical hazard to the volunteers and staff maneuvering the heavy objects into place on the goal frame. Due to the lack of an alternative, the difficulty of this process itself sometimes precludes these heavy objects being moved into place, thus leaving the goals unsecured.

In some cases, a pin is used to secure the goal to the ground. The pin may be a large spike or a U-shaped staple that is driven into the ground. In other cases, a chain is attached to the spike which is in turn used to secure the goal. In all cases, these solutions present a different type of hazard and unsatisfactory performance. The spike is easily loosened upon a force imposed on the goal resulting in the lifting of the cross-member off of the ground. Further, the spike is typically hard to drive under dry ground conditions resulting in the goal being unusable or, worse, use of the goal without a restraining device. The prior art also includes anchors consisting of helical auger style anchors which are semi-permanent. Driven goal anchors such as spikes and staples (even if driven through the ground bar (round goal frame) or ground shoe (square goal frame)) rely on friction with the earth to hold the anchor. Helical twist anchors must be screwed into the ground alongside the rear and side ground bars but cannot pull straight down on the ground bar. When used in semi-permanent applications on portable goals, driven spikes, U-shaped staples and helical twist anchors must be removed after each use to allow removal the goals from the playing field such that they can be securely and safely stored until further use (U.S. CPSC Guidelines for Movable Soccer Goal Safety). These listed anchors must be removed from the ground after each use to avoid accidents caused by tripping or otherwise contacting the anchors on the field of play. Since goals must be returned to the same location during use, the ability of any of these anchors to be securely held in place by being repeatedly driven into the ground in the same location is minimal.

Standard spike and staple anchors cannot be used to secure the net as well as the goal due to their metal composition and the type of application used to capture the goal's frame. These anchors would cut the net whereas the softer material of the strap anchor can wrap around and secure the goal frame as well as the net.

### BRIEF SUMMARY OF THE INVENTION

The instant invention, the Earth Anchor, is comprised of a foundation plate, a connecting column, a strap anchor bolt (pin), strap anchor guide and a strap anchor. The foundation plate is an essentially flat metal plate that is welded to the bottom of the connecting column. The foundation plate features either a drain hole or method of attachment to the connecting column that allows for drainage of moisture from the connecting column. The connecting column is a hollow cylinder or square tube that extends the depth of the excavated opening. The strap anchor bolt (pin) is secured through the connecting column by an opening formed in the connecting column near the top of the connecting column. The foundation plate, the connecting column, the strap anchor guide and the strap anchor bolt (pin) are manufactured from a metallic or rigid polymeric material. The strap anchor is a flexible material that is guided around the strap anchor bolt (pin) by the strap anchor guide and then around the goal ground bar (shoe) and is secured in place by the strap anchor locking assembly.

In the best mode of operation of the Earth Anchor, an opening is formed in the ground in the location of the sports goal and the Earth Anchor is placed in the opening. The opening is then backfilled with suitable materials and the strap anchor is secured around the sports goal frame to anchor the goal.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in this application to the details of construction and to the arrangements of the components set forth in the following description or illustrated in the drawings (See FIG. 5). The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. Additional benefits and advantages of the present invention will become apparent in those skilled in the art to which the present invention relates from the subsequent description of the preferred embodiment and the appended claims, taken in conjunction with the accompanying drawings. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application. The abstract is neither intended to define the invention of the application which is measured by the claims, nor is it intended to be limiting as to the scope of the invention in any way.

### BRIEF DESCRIPTION OF THE SEVERAL VIEWS OF THE DRAWING

FIG. 1 is a perspective view of the instant invention Earth Anchor.

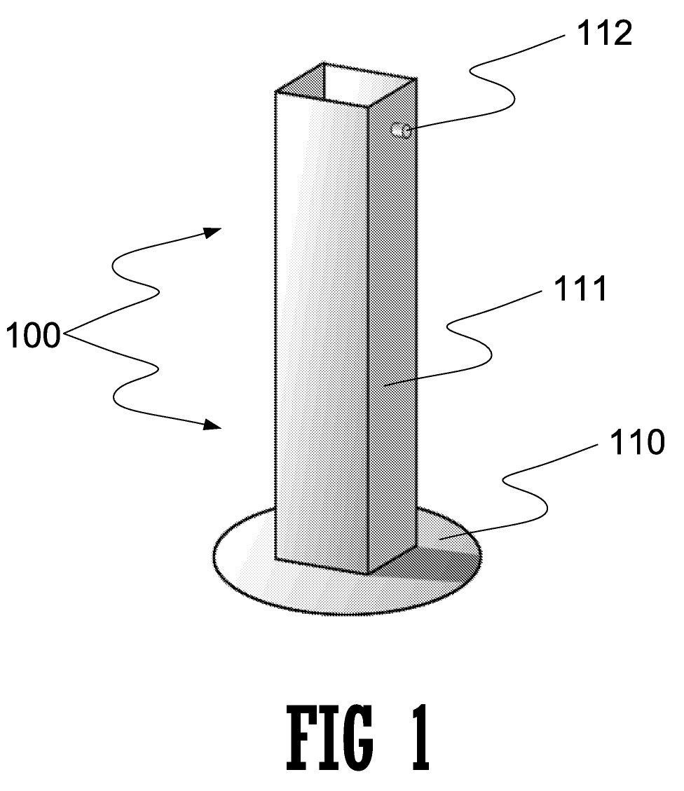

FIG. 2 is a perspective view of the Earth Anchor illustrating the instant invention as installed in the ground and secured to a goal.

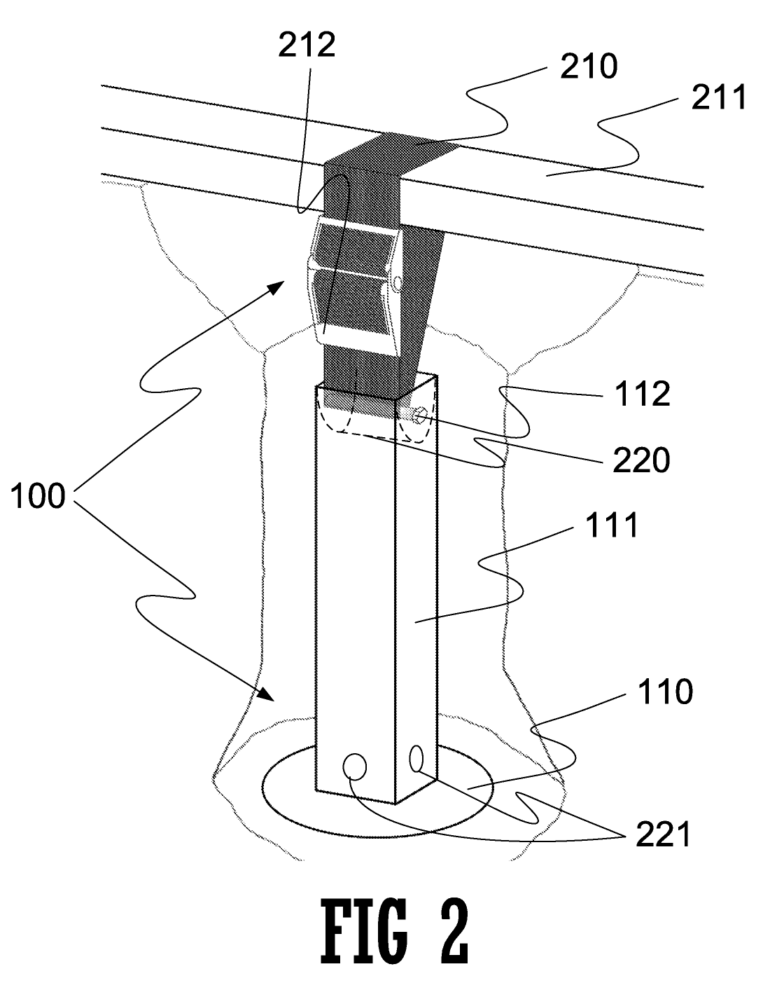

FIG. 3, three side views of the Earth Anchor are shown

FIG. 4 is a top view of the Earth Anchor

FIG. 5 shows an alternative embodiment employing a harness and a strap anchor.

### DETAILED DESCRIPTION OF THE INVENTION

The instant invention, the Earth Anchor 100, is comprised of a foundation plate 110, connecting column 111, strap anchor bolt (pin) 112, strap anchor guide 220, and a strap anchor 210.

The foundation plate 110 is an essentially flat metal plate that is permanently affixed to the bottom of the connecting column. The foundation plate 110 serves to provide support to the entire invention and sports goal by providing sufficient resistance to vertical movement. The foundation plate 110 provides this resistance when the instant invention is inserted into an opening in the ground, the instant invention is placed in the opening, and the opening is backfilled on the top of the foundation plate 110. The backfill can be the earth excavated to form the opening, gravel, rocks, cement, or any other material of sufficient density to adequately secure the invention in the opening. The foundation plate 110 provides the area for the backfill to secure the instant invention.

The connecting column 111 is a hollow cylinder that extends the depth of the excavated opening. The connecting column 111 can be of any cross sectional geometry, but in one preferred embodiment is of a square cross section. In another preferred embodiment the connecting column is of a circular cross section. The connecting column 111 can be manufactured in a variety of lengths to accommodate different goal weights and different soil conditions. Applications with difficult to penetrate soil may use a shorter connecting column 111. Applications with sandy or lighter soil may be accommodated with a longer connecting column. In the preferred embodiment of the instant invention the connecting column is approximately 12 inches in length.

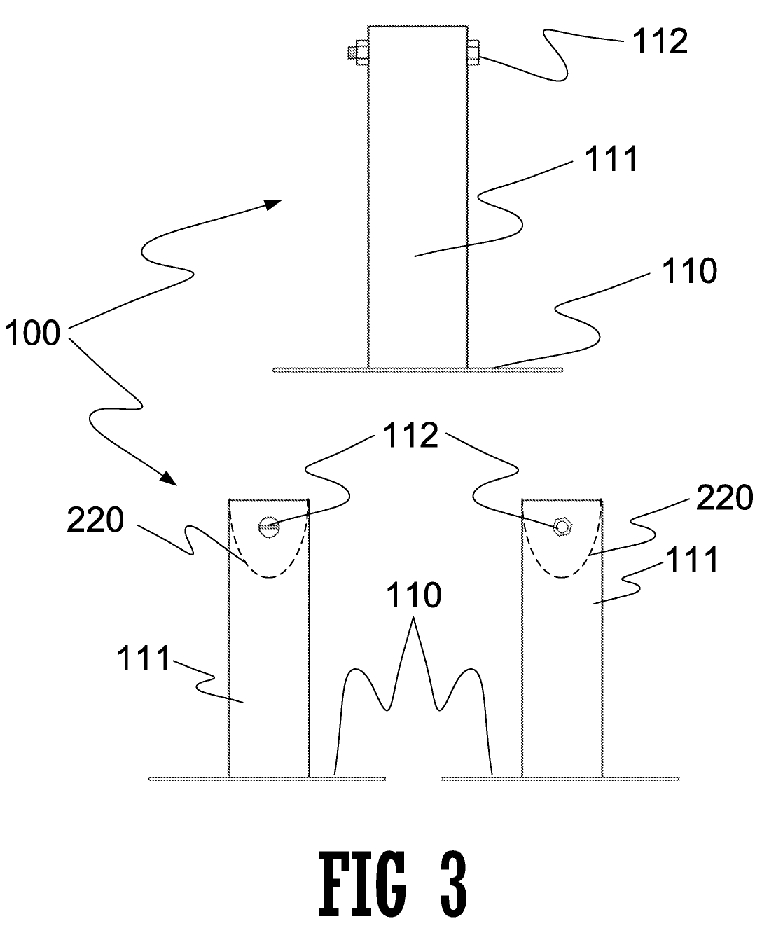

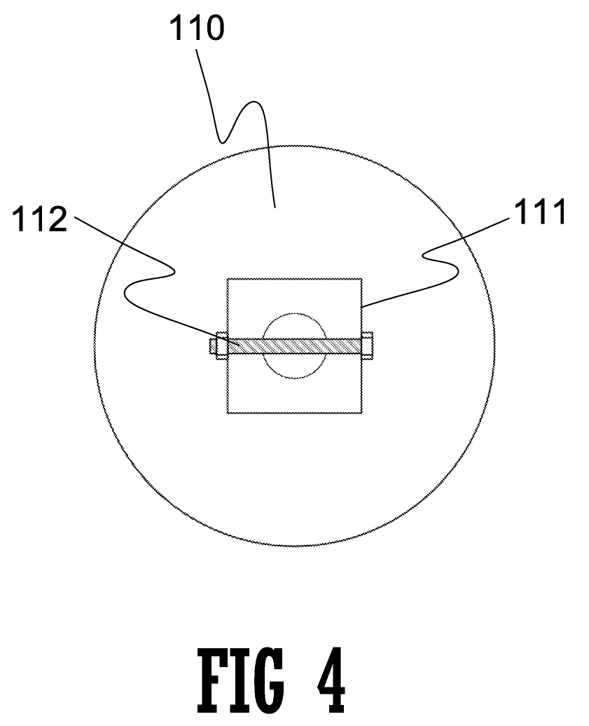

The strap anchor bolt (pin) 112 is secured through the connecting column 111 by an opening formed in the connecting column 111 near the top of the connecting column 111. The strap anchor bolt (pin) 112 is a bolt or pin with an enlarged head that prevents the strap anchor bolt (pin) from passing through the connecting column 111. The strap anchor bolt (pin) 112 is secured in place by a fastener. Where removal of the strap anchor bolt (pin) is not a necessary feature, the strap anchor bolt (pin) may in some applications be permanently affixed to the earth anchor through welding or other means. In one preferred embodiment of the instant invention the fastener is a nut as is illustrated in FIG. 3 and FIG. 4. In another preferred embodiment the fastener is a cotter pin placed through an aperture formed in the strap anchor bolt (pin) 112 at the end distal from the head of the strap anchor bolt (pin) 112. The fastener prevents the strap anchor bolt (pin) 112 from dislodging from the connecting column 111 while still being removable for maintenance of the strap anchor guide or to provide access when removing debris from the connecting column.

The foundation plate 110, the connecting column 111, the strap anchor guide, and the strap anchor bolt (pin) 112 are manufactured from a metallic or rigid polymeric material. In the preferred embodiment of the instant invention the foundation plate 110, the connecting column 111, the strap anchor guide 220, and the strap anchor bolt 112 are manufactured from carbon steel, stainless steel, or aluminum. After the Earth Anchor 100 is anchored into the hole in the ground, its ability to rotate is limited by using square tubing for the connecting column 111. In one preferred embodiment of the Earth Anchor 100 the connecting column 111 has a square cross section. In another preferred embodiment of the Earth Anchor the connecting column 111 has a round cross-section. In both of these preferred embodiments, the connecting column 111 can be hollow, solid, or filled with filler material to strengthen the connecting column 111 or to increase retention in the ground.

The strap anchor 210 is a flexible material that extends around the strap anchor bolt (pin) 112 and around the back or side ground shoe (bar) 211 of the goal. The back or side ground shoe (bar) 211 is broadly defined as any horizontal, vertical or corner member of a sporting goal. The back or side ground shoe (bar) 211 is permanently affixed to the remaining portion of the sporting goal and can serve as an appropriate goal support member to secure the entire sporting goal to the instant invention. One end of the strap anchor 210 is affixed to the strap anchor locking assembly 212 and the other end is threaded through the strap anchor locking assembly buckle 212. The length of the strap anchor 210 can be adjusted via the strap anchor locking assembly buckle 212 to provide a snug fit around the back or side ground shoe (bar) 211. The strap anchor locking assembly may not, in some applications, employ an actual buckle. Various types of clips or snaps may be used to join the strap anchor together.

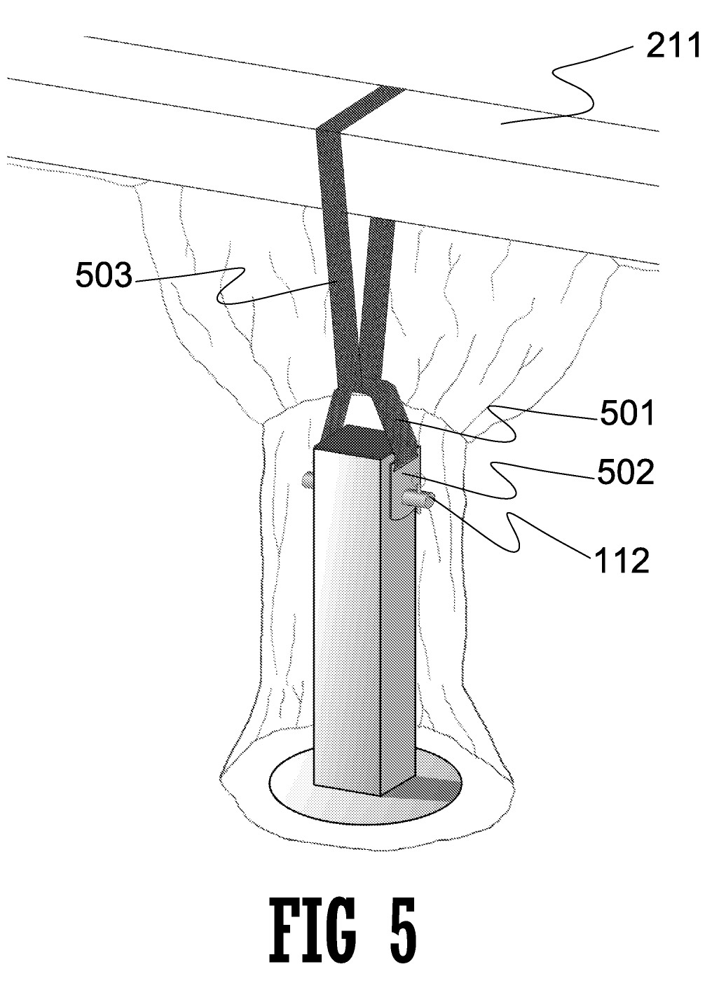

In another embodiment of the instant invention, the soccer goal is secured to the anchor through the use of two straps. Referring to FIG. 5, one strap, the harness 501, is comprised of woven fabric strap with stainless steel flanges 502 affixed on each of the two ends of the harness The harness is constructed of flexible woven fabric similar to the fabric used in car seat belts and is secured on the ends of the strap to two stainless steel flanges. The stainless steel flanges 502 form an aperture that accepts the anchor bolt in the instant invention 112. Each of the stainless steel flanges accepts an anchor bolt 112 on either side of the connecting column. In this embodiment, the top of the harness that anchor is attached to the connecting column (111) is placedinstalled in the ground so that the top of the anchor and the harness 501 is maintained several inches below the surface of the soil. This embodiment allows for the most effective and safest possible anchoring of the goal while still allowing for removal of the goal from the playing surface when not in use. Earth Anchor installation locations will be backfilled level with the playing surface with sand or suitable fill while not in use. The recessed harness (orange in color) is easily located beneath the ground surface to place the goal securely back in service. The soft fabric of the harness places additional space between the stainless steel connecting column of the earth anchor and the playing field surface while still allowing for connection to the Earth Anchor to the goal. This buffer space is the most important safety feature of the invention and insures its ease of use, strength and safety factor. Earth Anchor's ease of use will help to insure that field personnel will take the time to safely secure goals for the protection of the players.

The second strap, the strap anchor, 503 is threaded through the opening made by the harness and then is secured around the ground rail of the soccer goal. The strap anchor, 503 is constructed of similar woven fabric as the harness with securing means to secure the strap anchor around the bottom of the soccer goal. In one embodiment, the securing means are plastic snaps that secure the two ends around the bottom of the ground bar of the soccer goal. The fabric and plastic snaps of the strap anchor 503 virtually eliminate injury from contacting the hold-down system for the goal as offered by Earth Anchor. The metal fabrication of all current hold down solutions add additional possibility of injury to that of contacting the metal frame of the goal itself.

In the best mode of operation of the earth anchor 100, an opening is formed in the ground at the location of the sports goal. Forming a bell shaped cavity at the bottom of the excavation will increase the holding capacity of the earth anchor when the hole is backfilled with appropriate materials. The depth of the opening is slightly more than the length of the Earth Anchor 100. The Earth Anchor 100 is placed in the opening and the opening is filled with backfill. If the installation is intended to be permanent, the backfill is concrete. In some cases, simply backfilling with dry concrete mix is sufficient as the moisture inherent in the ground surrounding the instant invention will be sufficient to cure the concrete. The installation can also be made by using pre-mixed concrete or concrete mixed on the site. If the installation is intended to be temporary, dirt, gravel or rocks may be used to backfill the opening. This backfill may be removed later to change the location of the Earth Anchor 100. The connecting column 111 can be shortened and the strap anchor-bolt holes re-drilled to anchor an Earth Anchor 100 in locations where a hole cannot be dug deep enough to accept the standard size unit.

To attach the Earth Anchor 100 to the sports goal, the Earth Anchor 100 is then attached to the back or side ground shoe (bar) 211 via the strap anchor 210 and the strap anchor locking assembly 212. The Earth Anchor 100 is secured to the back or side ground shoe (bar) 211 by tightening the strap anchor 210 with the strap anchor locking assembly 212. Earth Anchors 100 may be used to secure goals in a face-to-face or face down location when not in use. (Most soccer goal injuries occur when soccer is not being officially played).

In the best mode of operation of the Earth Anchor when used in landscaping applications the landscape Earth Anchors will be green, sold in kits of three Earth Anchors with appropriate straps for attachment to trees and shrubs to control their growth. Since Earth Anchors can handle tension from any angle, triangulation will allow application of pulling pressure from any angle during the growth of the plant unlike stakes that have to be repositioned. The visual advantage is that the Earth Anchors are underground and not so unsightly as traditional above ground stakes. Newly staked trees can now be corrected for growth while still being a beautiful part of the landscape. Tensions on the correction straps can be much higher that those capable by anchoring to traditional stakes. Earth Anchors underground installation feature will eliminate lawn mower accidents and injuries by tripping and falling on above ground stakes. Straps used for attachment to trees will be designed to become as invisible as possible while still possessing the strength to correct the tree/shrub's growth pattern. Appropriate slings to protect the plant's limbs will be contained in the kit. Tie off rings can be provided to change the angle of tension. In general, earth anchors may be used to replace stakes and other traditional anchoring methods in any applicable application.

A key feature of the Earth Anchor is allowing a goal to be securely anchored in the same location time and time again. Driven anchors cannot be repeatedly used in the same location multiple times; the soil will simply not support it. The problem is that the goal does need to be positioned in the same location time and time again. Most goals will be positioned such that, after their removal, the Earth Anchor locations will not be on the playing field. Since Earth Anchors are recessed approximately 3″ below the playing surface, after capping the earth anchor to restrict dirt or sand from filling the connecting column a simple scoop of dirt or sand into the recess makes the playing surface smooth and removes any danger of tripping in the depression. This same procedure also allows Earth Anchor to be located on the playing field in situations where smaller goals are positioned in front of the full size goals for games by younger players.

Another best mode of operation of the Earth Anchor 100 is for securing pets on a tether or leash. If an animal is secured with a tethered line to a tree, stake, or helical twist style anchor, the one thing that is assured is that the animal will eventually wrap the tether around the anchor until his movement is severely limited. The Earth Anchor 100 offers an innovative alternative by attaching the animal's tether to the Earth Anchor 100 that is underground. The animal will maintain its full range of motion as determined by the length of the tether. This is important when an animal is kept on a tether where limitation of movement may keep the animal from shade, water, food or shelter.

What is claimed is:

1) An anchoring device comprised of
a foundation plate,
a connecting column, and
a strap anchor bolt.

2) The anchoring device described in claim 1 further comprising
a strap anchor, and
a strap anchor guide.

3) The anchoring device described in claim 1 further comprising
a harness,
a strap anchor, and
a strap anchor securing means to secure the strap anchor strap around a ground bar of a soccer goal.

4) The anchoring device described in claim 3
wherein the harness is constructed of flexible woven fabric,
wherein affixed on each of the two ends of the harness are stainless steel flanges,
wherein each of the stainless steel flanges form an aperture,
wherein the strap anchor is constructed of flexible woven fabric, and
wherein the strap anchor is threaded through the opening made by the harness and then is secured around the ground rail of the soccer goal.

5) The anchoring device described in claim 4 wherein the strap anchor securing means are plastic snaps that secure the two ends around the ground bar of the soccer goal.
